(19) United States
(12) Patent Application Publication
(10) Pub. No.: US 2026/0230705 A1
(43) Pub. Date: Aug. 6, 2026

(54) IMAGE PROCESSING METHOD, APPARATUS AND DEVICE, AND COMPUTER-READABLE STORAGE MEDIUM

(71) Applicant: Goertek Technology Co., Ltd., Qingdao, Shandong (CN)

(72) Inventor: Xudong Qiu, Shandong (CN)

(73) Assignee: Goertek Technology Co., Ltd., Qingdao, Shandong (CN)

(21) Appl. No.: 19/130,755

(22) PCT Filed: Nov. 16, 2023
(86) PCT No.: PCT/CN2023/132093

§ 371 Date: Apr. 28, 2026

(30) Foreign Application Priority Data
Nov. 17, 2022 (CN) 202211460824.8

(51) Int. Cl. H04N 23/68; G06T 1/00; G06T 1/20; G06T 3/10; G06T 3/20; G06T 7/20

(52) U.S. Cl. CPC H04N 23/6811; G06T 1/0007; G06T 1/20; G06T 3/10; G06T 3/20; G06T 7/20

(57) ABSTRACT

The disclosure provides an image processing method, apparatus and device, and a computer-readable storage medium. The image processing method includes: acquiring an original scene image and pixel movement information thereof; determining a target pixel in the original scene image and a movement trajectory thereof according to the pixel movement information; restoring the target pixel according to the movement trajectory to obtain a target scene image corresponding to the original scene image.

The present disclosure claims priority to a Chinese patent application No. 202211460824.8 filed with the CNIPA on Nov. 17, 2022 and entitled “IMAGE PROCESSING METHOD, APPARATUS AND DEVICE, AND COMPUTER-READABLE STORAGE MEDIUM”, which is hereby incorporated by reference in its entirety.

### TECHNICAL FIELD

The present disclosure relates to the technical field of processing images, and particularly to an image processing method, apparatus and device, and a computer-readable storage medium.

### BACKGROUND

With the VR (Virtual Reality) and AR (Augmented Reality) industries experiencing a surge in recent years, their value has become increasingly evident across various sectors such as industry, healthcare, entertainment, office work, and social interaction. Currently, major manufacturers are actively exploring and investing in the field of MR (Mixed Reality).

The primary technical approach to achieving MR today is based on VST (Video See-Through) technology. In VST technology, a camera captures a real-time view of the real world, which is then integrated with a virtual view from the digital world and displayed on a screen to deliver the integrated image to the user's eyes. The VST technology allows for full control over visual integration, enabling complete occlusion between virtual and real objects, and even permitting more advanced modifications to real objects.

However, the cameras used in VST technology to capture real-world scenes typically employ a rolling shutter. Consequently, under conditions such as long exposure times, camera shake, or movement of external objects, the captured images are prone to motion blur or smearing, leading to degraded output image quality and negatively affecting the user's MR experience.

### SUMMARY

The main objective of the present disclosure is to provide an image processing method, apparatus and device, and a computer-readable storage medium, which are intended to address the technical problem that the images are prone to motion blur or smearing under conditions such as long exposure times, camera shake, or movement of external objects.

To achieve the above objective, in a first aspect, the present disclosure provides an image processing method, comprising:
acquiring an original scene image and pixel movement information of the original scene image;
determining a target pixel in the original scene image and a movement trajectory of the target pixel according to the pixel movement information; and
restoring the target pixel according to the movement trajectory to obtain a target scene image corresponding to the original scene image.

Based on the above technical solution, by acquiring an original scene image and pixel movement information of the original scene image; determining a target pixel in the original scene image and a movement trajectory of the target pixel according to the pixel movement information; and restoring the target pixel according to the movement trajectory to obtain a target scene image corresponding to the original scene image, the present embodiment, by restoring the target pixel based on the movement trajectory of the target pixel, eliminates the motion blur in the original scene image under conditions such as long exposure times, camera shake, or movement of external objects, acquires the target scene image corresponding to the original scene image, addresses the technical problem that the images are prone to motion blur or smearing under conditions such as long exposure times, camera shake, or movement of external objects, improves the clarity of the output image and ensures the user's MR experience.

According to the first aspect, said “restoring the target pixel according to the movement trajectory to obtain a target scene image corresponding to the original scene image” comprises:
determining a starting position of the target pixel within an exposure period of the original scene image according to the movement trajectory;
acquiring a filling pixel for a current position of the target pixel; and
moving the target pixel from the current position to the starting position, and filling the current position with the filling pixel to obtain the target scene image corresponding to the original scene image.

Based on the above technical solution, by determining a starting position of the target pixel within an exposure period of the original scene image according to the movement trajectory and acquiring a filling pixel for a current position of the target pixel, on one hand, the target pixel is moved from the current position to the starting position so that all target pixels are restored to their positions at the beginning of exposure (i.e., initial positions), and then, the filling pixel is filled into the current position to fill the vacancy left at the current position after the target pixel has moved from the current position to the starting position, so as to acquire the target scene image corresponding to the original scene image.

According to the first aspect, or any implementation of the first aspect above, said “acquiring a filling pixel for a current position of the target pixel” includes:
acquiring a target scene image of the previous frame and inter-frame pixel movement information between the target scene image of the previous frame and the original scene image;
determining an initial pixel at the current position within the exposure period of the original scene image according to the target scene image of the previous frame and the inter-frame pixel movement information, and using the initial pixel as the filling pixel for the current position.

Based on the above technical solution, by means of the target scene image of the previous frame and the inter-frame pixel movement information between the target scene image of the previous frame and the original scene image, it is possible to improve the accuracy of the filling pixel for filling the vacancy of the current position, and to ensure the accuracy of the output target scene image. In addition, by means of the target scene image of the previous frame and the inter-frame pixel movement information, it is also possible to effectively reduce the amount of data for image processing, to avoid the need to update the initial EVS image in real time, and to improve the image processing efficiency.

According to the first aspect, or any implementation of the first aspect above, said “determining a target pixel in the original scene image and a movement trajectory of the target pixel according to the pixel movement information” includes:
determining a moving pixel that moves within an exposure period in the original scene image according to the pixel movement information, and using the moving pixel as the target pixel;
determining a starting position of the target pixel within the exposure period according to the pixel movement information;
generating the movement trajectory of the target pixel according to the starting position and a current position of the target pixel.

Based on the above technical solution, by determining a moving pixel that moves within an exposure period in the original scene image according to the pixel movement information, and using the moving pixel as the target pixel; determining a starting position of the target pixel within the exposure period according to the pixel movement information; and generating the movement trajectory of the target pixel according to the starting position and a current position of the target pixel. The present embodiment, according to the pixel point movement information, determines the target pixel in the original scene image that has moved and the movement trajectory of the target pixel during the exposure period of the standard camera, so as to restore the position of the target pixel based on the movement trajectory subsequently.

According to the first aspect, or any implementation of the first aspect above, before acquiring the original scene image, the method includes:
capturing a target scene using a standard camera to obtain an original scene image corresponding to the target scene.

Based on the above technical solution, it is possible to acquire the original scene image with possible motion blur by capturing the target scene with a standard camera.

According to the first aspect, or any implementation of the first aspect above, before acquiring pixel movement information of the original scene image, the method includes:
collecting the pixel movement information of the original scene image using an event-driven camera within an exposure period of the original scene image.

Based on the above technical solution, collecting the pixel movement information of the original scene image using an event-driven camera within an exposure period of the original scene image, so as to determine the target pixel in the original scene image that has moved and the movement trajectory of the target pixel within the exposure period for restoring the position of the target pixel.

According to the first aspect, or any implementation of the first aspect above, before determining a target pixel in the original scene image and a movement trajectory of the target pixel according to the pixel movement information, the image processing method further includes:
using the original scene image as a target scene image when the pixel movement information indicates clear of motion blur, and outputting the target scene image.

Based on the above technical solution, by outputting the original scene image as the target scene image directly when the pixel movement information indicates clear of motion blur, it is possible to effectively improve the processing efficiency of the original scene image.

In a second aspect, the present disclosure provides an image processing apparatus, which includes:
an acquiring module configured for acquiring an original scene image and pixel movement information of the original scene image;
a determining module configured for determining a target pixel in the original scene image and a movement trajectory of the target pixel according to the pixel movement information; and
a restoring module configured for restoring the target pixel according to the movement trajectory to obtain a target scene image corresponding to the original scene image.

According to the second aspect, the restoring module is further configured for:
determining a starting position of the target pixel within an exposure period of the original scene image according to the movement trajectory;
acquiring a filling pixel for a current position of the target pixel; and moving the target pixel from the current position to the starting position, and filling the current position with the filling pixel to obtain the target scene image corresponding to the original scene image.

According to the second aspect, or any implementation of the second aspect above, the restoring module is further configured for:
acquiring a target scene image of the previous frame and inter-frame pixel movement information between the target scene image of the previous frame and the original scene image; and
determining an initial pixel at the current position within the exposure period of the original scene image according to the target scene image of the previous frame and the inter-frame pixel movement information, and using the initial pixel as the filling pixel for the current position.

According to the second aspect, or any implementation of the second aspect above, the determining module is further configured for:
determining a moving pixel that moves within an exposure period in the original scene image according to the pixel movement information, and using the moving pixel as the target pixel;
determining a starting position of the target pixel within the exposure period according to the pixel movement information; and generating the movement trajectory of the target pixel according to the starting position and a current position of the target pixel.

According to the second aspect, or any implementation of the second aspect above, the image processing apparatus further includes a first camera module, which is configured for:
capturing a target scene using a standard camera to obtain an original scene image corresponding to the target scene.

According to the second aspect, or any implementation of the second aspect above, the image processing apparatus further includes a second camera module, which is configured for:
collecting the pixel movement information of the original scene image using an event-driven camera within an exposure period of the original scene image.

According to the second aspect, or any implementation of the second aspect above, the image processing apparatus further includes a direct transmission module, which is configured for:
using the original scene image as a target scene image when the pixel movement information indicates clear of motion blur, and outputting the target scene image.

The second aspect, or any implementation of the second aspect corresponds to the first aspect, or any implementation of the first aspect above respectively. The technical effects corresponding to the second aspect, or any implementation of the second aspect may refer to those corresponding to the above first aspect, or any implementation of the first aspect, and will not be repeated herein.

In a third aspect, the present disclosure provides an image processing device, which includes: a memory, a processor, and a computer program stored on the memory and executable on the processor, wherein the computer program is configured for implementing steps of the above image processing method.

The third aspect, or any implementation of the third aspect corresponds to the first aspect, or any implementation of the first aspect respectively. The technical effects corresponding to the third aspect, or any implementation of the third aspect may refer to those corresponding to the above first aspect, or any implementation of the first aspect, and will not be repeated herein.

In a fourth aspect, the present disclosure provides a computer-readable storage medium, the computer-readable storage medium stores a computer program thereon, which, when executed by a processor, enables the processor to execute the image processing method according to the above first aspect, or any possible implementation of the first aspect.

The fourth aspect, or any implementation of the fourth aspect corresponds to the first aspect, or any implementation of the first aspect respectively. The technical effects corresponding to the fourth aspect, or any implementation of the fourth aspect may refer to those corresponding to the above first aspect, or any implementation of the first aspect, and will not be repeated herein.

In a fifth aspect, the embodiments of the present disclosure provides a computer program, which includes instructions for performing the image processing method according to the first aspect, or any possible implementation of the first aspect.

The fifth aspect, or any implementation of the fifth aspect corresponds to the first aspect, or any implementation of the first aspect respectively. The technical effects corresponding to the fifth aspect, or any implementation of the fifth aspect may refer to those corresponding to the above first aspect, or any implementation of the first aspect, and will not be repeated herein.

Other features and advantages of the present disclosure will become apparent from the following detailed description of exemplary embodiments of the present disclosure with reference to the accompanying drawings.

### BRIEF DESCRIPTION OF THE DRAWINGS

FIG. 1 shows a schematic diagram of a video perspective technique involved in an embodiment of the present disclosure;

FIG. 2 shows a structural schematic diagram of an image processing device of a hardware operating environment involved in an embodiment of the present disclosure;

FIG. 3 shows a schematic diagram of a flow of a first embodiment of the image processing method of the present disclosure;

FIG. 4 shows a schematic diagram of a flow of a second embodiment of the image processing method of the present disclosure;

FIG. 5 shows a structural schematic diagram of an image processing apparatus involved in an embodiment of the present disclosure.

The realization of the objects, functional features and advantages of the present disclosure will be further described in conjunction with the embodiments and with reference to the accompanying drawings.

### DETAILED DESCRIPTION

The technical solutions in the embodiments of the present disclosure will be clearly and completely described below with reference to the drawings in the embodiments of the present disclosure. Obviously, the described embodiments are merely some rather than all of the embodiments of the present disclosure. Based on the embodiments of the present disclosure, all other embodiments obtained by a person of ordinary skill in the art without any creative effort fall within the protection scope of the present disclosure.

The term “and/or” used herein merely describes an association relationship between associated objects, indicating that three relationships may exist. For example, A and/or B can indicate: the existence of A alone, the simultaneous existence of both A and B, or the existence of B alone.

The terms “first” and “second” and the like in the specification and claims of the embodiments of the present disclosure are used to distinguish between different objects and are not used to describe a particular order of objects. For example, a first target object and a second target object, etc. are used to distinguish between different target objects, rather than to describe a particular order of target objects.

In the embodiments of the present disclosure, words like “exemplary” or “for example” are used to denote examples, illustrations, or explanations. Any embodiment or design scheme described as “exemplary” or introduced with “for example” in the embodiments of the present disclosure should not be construed as being preferred or advantageous over other embodiments or design schemes. The use of “exemplary” or “for example” aims to specifically illustrate relevant concepts.

In the description of embodiments of the present disclosure, unless otherwise indicated, “a plurality” means two or more. For example, a plurality of processing units means two or more processing units; a plurality of systems means two or more systems.

For the sake of clarity and conciseness in the description of the following embodiments, a brief description of an implementation scheme of an image processing method is first given:

With the VR (Virtual Reality) and AR (Augmented Reality) industries experiencing a surge in recent years, their value has become increasingly evident across various sectors such as industry, healthcare, entertainment, office work, and social interaction. Currently, major manufacturers are actively exploring and investing in the field of MR (Mixed Reality).

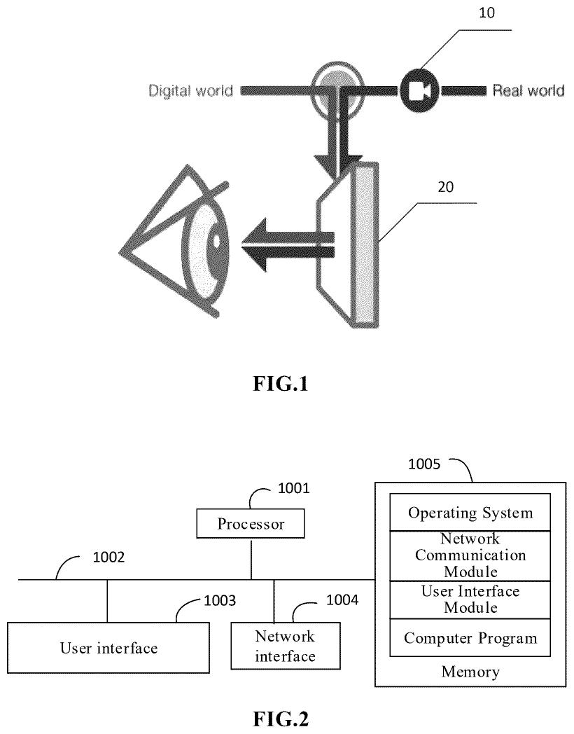

The primary technical approach to achieving MR today is based on VST (Video See-Through) technology. Referring to FIG. 1, it shows a schematic diagram of a video perspective technique involved in an embodiment of the present disclosure. In VST technology, a camera 10 captures a real-time view of the real world, which is then integrated with a virtual view from the digital world and displayed on a screen 20 to deliver the integrated image to the user's eyes. The VST technology allows for full control over visual integration, enabling complete occlusion between virtual and real objects, and even permitting more advanced modifications to real objects.

However, the cameras used in VST technology to capture real-world scenes typically employ a rolling shutter. Consequently, under conditions such as long exposure times, camera shake, or movement of external objects, the images are prone to motion blur or smearing, leading to degraded output image quality and negatively affecting the user's MR experience.

The present disclosure designs an image processing method for restoring the original scene image using pixel movement information, and thus addresses the technical problem that the images are prone to motion blur or smearing under conditions such as long exposure times, camera shake, or movement of external objects, therefore improving the clarity of the output image and ensures the user's MR experience.

In some embodiments, by acquiring an original scene image and pixel movement information of the original scene image; determining a target pixel in the original scene image and a movement trajectory of the target pixel according to the pixel movement information; and restoring the target pixel according to the movement trajectory to obtain a target scene image corresponding to the original scene image, the present embodiment, by restoring the target pixel based on the movement trajectory of the target pixel, eliminates the motion blur in the original scene image under conditions such as long exposure times, camera shake, or movement of external objects, acquires the target scene image corresponding to the original scene image, addresses the technical problem that the images are prone to motion blur or smearing under conditions such as long exposure times, camera shake, or movement of external objects, improves the clarity of the output image and ensures the user's MR experience.

Referring to FIG. 2, it shows a structural schematic diagram of an image processing device of a hardware operating environment involved in an embodiment of the present disclosure.

Specifically, the image processing device can be a MR device, PC (Personal Computer), tablet computer, portable computer, or server, etc.

As shown in FIG. 2, the image processing device may include: a processor 1001, such as a CPU (Central Processing Unit), a communication bus 1002, a user interface 1003, a network interface 1004, and a memory 1005. Herein, the communication bus 1002 is used to achieve connection communication between these components. The user interface 1003 may include a display, and an input unit such as a keyboard. Optionally, the user interface 1003 may also include standard wired interfaces and wireless interfaces. The network interface 1004 optionally includes standard wired interfaces and wireless interfaces (such as Wireless-Fidelity (Wi-Fi) interfaces). The memory 1005 can be high-speed Random Access Memory (RAM) storage, or stable non-volatile memory (NVM), such as disk storage. Optionally, the memory 1005 can also be a storage device independent of the aforementioned processor 1001.

Those skilled in the art can understand that the structure illustrated in FIG. 2 does not constitute a limitation on the image processing device; it may include more or fewer components than those shown in the figure, or combine certain components, or different component arrangements.

As shown in FIG. 2, the memory 1005, as a storage medium, may include an operating system, a data storage module, a network communication module, a user interface module, and computer programs.

In the image processing device shown in FIG. 2, the network interface 1004 is mainly used for data communication with other devices; the user interface 1003 is mainly used for data interaction with users. The processor 1001 and the memory 1005 in the image processing device of the present disclosure can be disposed within the image processing device. The image processing device invokes the computer program stored in the memory 1005 through the processor 1001, and executes the image processing method provided by the embodiment of the present disclosure.

It should be understood that the above description is merely exemplary to better understand the technical solution of the present embodiment, and shall not be construed as the only limitation thereof.

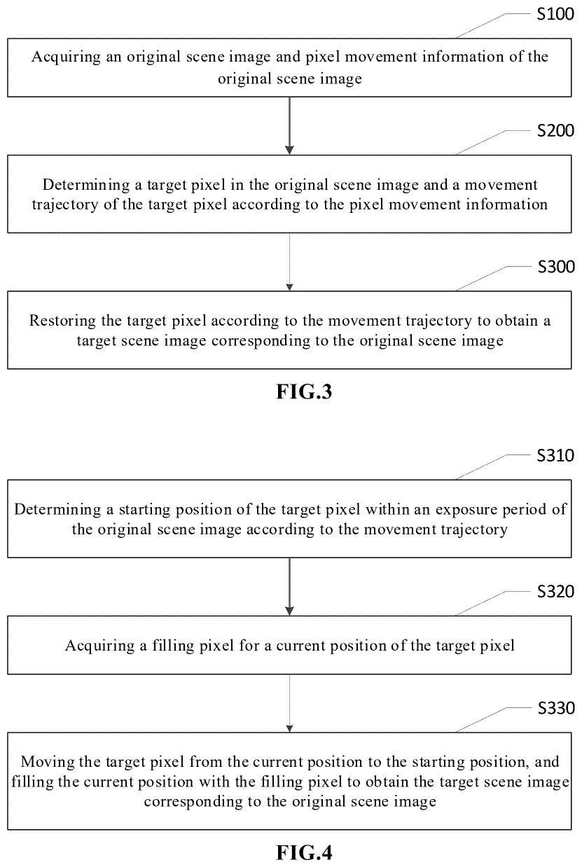

The following describes the image processing method in detail with the schematic diagram of the flow of the first embodiment of the image processing method shown in FIG. 3.

Referring to FIG. 3, the image processing method provided by an embodiment of the present disclosure includes:
Step S100, acquiring an original scene image and pixel movement information of the original scene image;

In the present embodiment, it should be noted that the original scene image is obtained by capturing the target scene using a standard camera, wherein the standard camera is equipped with conventional image sensors such as a CIS (CMOS Image Sensor). The pixel point movement information at least includes movement information such as coordinate positions of pixel points of the original scene image collected by EVS (Event-based Vision Sensor) in an exposure period in the imaging frame of the standard camera and time points corresponding to the coordinate positions. It can be understood that an event-driven camera equipped with the EVS can be adopted to collect the pixel movement information.

Herein, before acquiring an original scene image in step S100, the method includes:
Step S110, capturing a target scene using a standard camera to obtain an original scene image corresponding to the target scene.

Specifically, the target scene is a scene that the user desires to capture. In the present embodiment, the original scene image corresponding to the target scene can be obtained by capturing the target scene with the standard camera. Herein, before acquiring pixel movement information of the original scene image in step S100, the method includes:
Step S120, collecting the pixel movement information of the original scene image using an event-driven camera within an exposure period of the original scene image.

In the present embodiment, it should be noted that the exposure period refers to the duration from the moment the shutter of the standard camera opens to the moment the pixels in the original image frame are exposed, during the process of capturing the target scene using the standard camera to obtain the original scene image. Taking the standard camera with the rolling shutter as an example, it is achieved by way of progressive exposure by CIS. At the start of exposure, the CIS scans the imaging frame of the standard camera line by line and exposes it line by line until all pixels of the imaging frame are exposed, so as to obtain the original scene image. It is understandable that the CIS is charge-based and needs to be integrated before it can have an output. In other words, during this charge integration process, the CIS pixels do not distinguish changes occurring within this process, which limits the sampling frequency of the standard camera. In contrast, the EVS is based on the PD (Photo-Diode) current, and monitors whether the current signal of the PD has changed. If the change exceeds a given threshold, taking a 2-bit signal output as an example, the output can be “01” if the current signal strengthens, and “10” if the current signal weakens. If the change in the current signal does not exceed the threshold, the output is “00”. Meanwhile, its calculation process involves all pixels undergoing analog-to-digital conversion simultaneously, which is a parallel process. Moreover, since the conversion is simple, this 2-bit analog-to-digital conversion is very fast, thereby achieving extremely rapid conversion and output of the entire pixel array. Therefore, the sampling frequency of the event-driven camera is much higher than that of the standard camera.

As an example, both a standard camera using CIS and an event-driven camera using EVS can be disposed into the MR device, such that in a process of capturing the target scene using the standard camera to obtain the original scene image, the pixel movement information of the original scene image can be collected by the event-driven camera within the exposure period of the original scene image. Herein, the pixel point movement information at least includes movement information such as coordinate positions of pixel points of the original scene image collected by EVS in an exposure period in the imaging frame of the standard camera and time points corresponding to the coordinate positions.
Step S200, determining a target pixel in the original scene image and a movement trajectory of the target pixel according to the pixel movement information;

After obtaining the pixel movement information, it is then possible to determine, according to the pixel movement information, the pixels that have moved within the exposure period of the original scene image (i.e., the target pixels in the original scene image) and the movement trajectories of these target pixels within the exposure period.

Herein, the step 200 of determining a target pixel in the original scene image and a movement trajectory of the target pixel according to the pixel movement information includes:
Step S210, determining a moving pixel that moves within an exposure period in the original scene image according to the pixel movement information, and using the moving pixel as the target pixel;
Step S220, determining a starting position of the target pixel within the exposure period according to the pixel movement information;
Step S230, generating the movement trajectory of the target pixel according to the starting position and a current position of the target pixel.

It can be understood that the EVS detects changes in each pixel within the imaging frames in an asynchronous manner, and thus can determine a moving pixel that moves within an exposure period in the original scene image according to the pixel movement information, and using the moving pixel as the target pixel, then determine a starting position of the target pixel within the exposure period according to the pixel movement information (that is, the target pixel is at the position at the beginning of exposure), and then can generate the movement trajectory of the target pixel according to the starting position and a current position of the target pixel.

The present embodiment determines a moving pixel that moves within an exposure period in the original scene image according to the pixel movement information, and using the moving pixel as the target pixel, determines a starting position of the target pixel within the exposure period according to the pixel movement information, and generates the movement trajectory of the target pixel according to the starting position and a current position of the target pixel. The present embodiment, according to the pixel point movement information, determines the target pixel in the original scene image that has moved and the movement trajectory of the target pixel during the exposure period of the standard camera, so as to restore the position of the target pixel based on the movement trajectory subsequently.
Step S300, restoring the target pixel according to the movement trajectory to obtain a target scene image corresponding to the original scene image.

After obtaining the movement trajectory of the target pixel, it is possible to determine the position of the target pixel on the original scene image at the beginning of the exposure on the imaging plane (i.e., the initial position of the target pixel during the exposure period of the original scene image). Then, the target pixel can be restored to the initial position, so as to eliminate the motion blur caused by conditions such as long exposure times, camera shake, or movement of external objects, thereby acquiring the target scene image with the motion blur eliminated corresponding to the original scene image.

Further, before determining a target pixel in the original scene image and a movement trajectory of the target pixel according to the pixel movement information, the image processing method further includes:
Step S400, using the original scene image as a target scene image when the pixel movement information indicates clear of motion blur, and outputting the target scene image.

It can be understood that, according to the pixel point movement information, it can be determined whether the capturing of the standard camera generates the motion blur. For example, the number of the target pixel points is determined according to the motion information of the pixel points, and when the number of the target pixel points is lower than a preset proportional threshold (0.3%, 0.5%, 1.0%, etc.), it indicates that the standard camera does not generate the motion blur when capturing the original scene image, and it can be determined that the motion information of the pixel point indicates clear of motion blur. When the number of the target pixel points is not lower than preset proportion threshold, it indicates that the standard camera generates a motion blur when capturing the original scene image, and then it can be determined that the motion information of the pixel points indicates the existence of the motion blur, and step S200 is performed.

The present embodiment, by outputting the original scene image as the target scene image directly when the pixel movement information indicates clear of motion blur, can effectively improve the processing efficiency of the original scene image.

In the first embodiment of the present disclosure, by acquiring an original scene image and pixel movement information of the original scene image; determining a target pixel in the original scene image and a movement trajectory of the target pixel according to the pixel movement information; restoring the target pixel according to the movement trajectory to obtain a target scene image corresponding to the original scene image, the present embodiment, by restoring the target pixel based on the movement trajectory of the target pixel, eliminates the motion blur in the original scene image under conditions such as long exposure times, camera shake, or movement of external objects, acquires the target scene image corresponding to the original scene image, addresses the technical problem that the images are prone to motion blur or smearing under conditions such as long exposure times, camera shake, or movement of external objects, improves the clarity of the output image and ensures the user's MR experience.

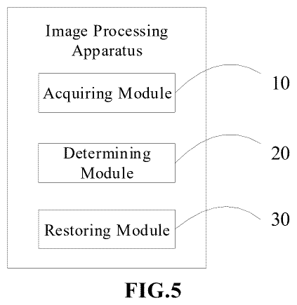

The following describes the image processing method in detail with the schematic diagram of the flow of the second embodiment of the image processing method shown in FIG. 4.

Referring to FIG. 4, in the image processing method provided by another embodiment of the present disclosure, the step S300 of restoring the target pixel according to the movement trajectory to obtain a target scene image corresponding to the original scene image includes:
Step S310, determining a starting position of the target pixel within an exposure period of the original scene image according to the movement trajectory;
Step S320, acquiring a filling pixel for a current position of the target pixel;
Step S330, moving the target pixel from the current position to the starting position, and filling the current position with the filling pixel to obtain the target scene image corresponding to the original scene image.

In the present embodiment, determining a starting position of the target pixel within an exposure period of the original scene image according to the movement trajectory (that is, the position of the target pixel on the original scene image at the beginning of exposure on the imaging frame). Since the current position will lack pixel after the target pixel is restored from its current position back to the starting position, it is also necessary to acquire a filling pixel for the target pixel at the current position thereof for filling the vacancy left after the target pixel is moved to the starting position. As an example, since all the pixels in the imaging frame are moving pixels once the event-driven camera is turned on, at this moment, all the pixels on the imaging frame can be acquired to obtain the initial EVS image. Then, by collecting real-time pixel movement information, the initial EVS image can be updated to acquire a real-time EVS image. Following this, based on the real-time EVS image, the current EVS image corresponding to the starting moment of the exposure period of the original scene image can be determined, and the pixel at the current position in the current EVS image is used as the corresponding filling pixel. Subsequently, the target pixel can be moved from the current position to the starting position, and the current position is filled with the filling pixel to obtain the target scene image corresponding to the original scene image.

In the present embodiment, by determining a starting position of the target pixel within an exposure period of the original scene image according to the movement trajectory and acquiring a filling pixel for a current position of the target pixel, on one hand, the target pixel is moved from the current position to the starting position so that all target pixels are restored to their positions at the beginning of exposure (i.e., initial positions), and then, the filling pixel is filled into the current position to fill the vacancy left at the current position after the target pixel has moved from the current position to the starting position, so as to acquire the target scene image corresponding to the original scene image.

Herein, the step S320 of acquiring a filling pixel for a current position of the target pixel includes:
Step S321, acquiring a target scene image of the previous frame and inter-frame pixel movement information between the target scene image of the previous frame and the original scene image;
Step S322, determining an initial pixel at the current position within the exposure period of the original scene image according to the target scene image of the previous frame and the inter-frame pixel movement information, and using the initial pixel as the filling pixel for the current position.

The present embodiment, by acquiring a target scene image of the previous frame and inter-frame pixel movement information between the target scene image of the previous frame and the original scene image, determining an initial pixel at the current position within the exposure period of the original scene image according to the target scene image of the previous frame and the inter-frame pixel movement information (that is, the pixel on the imaging frame of the current position on the original scene image when exposure begins), and using the initial pixel as the filling pixel for the current position, can fill the vacancy left by the current position after the target pixel is moved from the current position to the starting position, thereby ensuring the integrity of the output target scene image.

The present embodiment, by means of the target scene image of the previous frame and the inter-frame pixel movement information between the target scene image of the previous frame and the original scene image, improves the accuracy of the filling pixel used to fill the vacancy at the current position, ensuring the accuracy of the output target scene image. Additionally, by using the target scene image of the previous frame and the inter-frame pixel movement information, it is possible to effectively reduce the data volume of image processing, avoids the need for real-time updates of the initial EVS image, and enhances image processing efficiency.

Referring to FIG. 5, FIG. 5 shows a structural schematic diagram of an image processing apparatus involved in the embodiment of the present disclosure.

Referring to FIG. 5, the present disclosure provides an image processing apparatus, which includes:
an acquiring module 10 configured for acquiring an original scene image and pixel movement information of the original scene image;
a determining module 20 configured for determining a target pixel in the original scene image and a movement trajectory of the target pixel according to the pixel movement information; and
a restoring module 30 configured for restoring the target pixel according to the movement trajectory to obtain a target scene image corresponding to the original scene image.

Optionally, the restoring module 30 is further configured for:
determining a starting position of the target pixel within an exposure period of the original scene image according to the movement trajectory;
acquiring a filling pixel for a current position of the target pixel;
moving the target pixel from the current position to the starting position, and filling the current position with the filling pixel to obtain the target scene image corresponding to the original scene image.

Optionally, the restoring module 30 is further configured for:
acquiring a target scene image of the previous frame and inter-frame pixel movement information between the target scene image of the previous frame and the original scene image;
determining an initial pixel at the current position within the exposure period of the original scene image according to the target scene image of the previous frame and the inter-frame pixel movement information, and using the initial pixel as the filling pixel for the current position.

Optionally, the determining module 20 is further configured for:
determining a moving pixel that moves within an exposure period in the original scene image according to the pixel movement information, and using the moving pixel as the target pixel;
determining a starting position of the target pixel within the exposure period according to the pixel movement information;
generating the movement trajectory of the target pixel according to the starting position and a current position of the target pixel.

Optionally, the image processing apparatus further includes a first camera module, which is configured for:
capturing a target scene using a standard camera to obtain an original scene image corresponding to the target scene.

Optionally, the image processing apparatus further includes a second camera module, which is configured for:
collecting the pixel movement information of the original scene image using an event-driven camera within an exposure period of the original scene image.

Optionally, the image processing apparatus further includes a direct transmission module, which is configured for:
using the original scene image as a target scene image when the pixel movement information indicates clear of motion blur, and outputting the target scene image.

It can be understood that the image processing apparatus implements the operations in the image processing method provided in the above embodiments, and the specific implementation steps can be referred to the description contents of the above embodiments, which will not be repeated herein.

In addition, the embodiment of the present disclosure further proposes a computer-readable storage medium, and the computer-readable storage medium stores a computer program thereon, which, when executed by a processor, implements operations of the image processing method provided in the above embodiments. The specific steps will not be repeated herein.

It should be further noted that herein, the terms “comprise”, “contain”, or any other variation thereof, are intended to cover a non-exclusive inclusion, such that a process, method, object, or system that comprises a list of elements does not include only those elements but may include other elements not expressly listed, or elements inherent to such process, method, object, or system. Without further restrictions, an element qualified by the statement “including a . . . ” does not exclude the existence of another identical element in the process, method, object, or system comprising the element.

The numbers provided in the embodiments of the above disclosure are for illustrative purposes only and do not represent the superiority or inferiority of the embodiments.

Through the description of the above implementation, those skilled in the art can clearly understand that the above method embodiments can be implemented using software plus a necessary general-purpose hardware platform, and of course through hardware. However, in many cases, the former is a better implementation way. Based on this understanding, the technical solution of the present disclosure, essentially or the part that makes a contribution to the prior art, can be embodied in the form of a software product. This computer software product is stored in a storage medium (such as ROM/RAM, magnetic disk, optical disc) as mentioned above and includes several instructions to enable a terminal device (which can be a mobile phone, computer, server, or network device, etc.) to execute the method described in various embodiments of the present disclosure.

The above are only the preferred embodiments of the present disclosure and do not limit the patent scope of the present disclosure. Any equivalent structural or equivalent process transformation made using the content of the specification and drawings of the present disclosure, or directly or indirectly applied in other related technical fields, shall also be included in the patent protection scope of the present disclosure.

1. An image processing method, comprising:
acquiring an original scene image and pixel movement information thereof;
determining a target pixel in the original scene image and a movement trajectory thereof according to the pixel movement information; and
restoring the target pixel according to the movement trajectory to obtain a target scene image corresponding to the original scene image.

2. The image processing method according to claim 1, wherein said “restoring the target pixel according to the movement trajectory to obtain a target scene image corresponding to the original scene image” comprises:
determining a starting position of the target pixel within an exposure period of the original scene image according to the movement trajectory;
acquiring a filling pixel for a current position of the target pixel; and
moving the target pixel from the current position to the starting position, and filling the current position with the filling pixel to obtain the target scene image corresponding to the original scene image.

3. The image processing method according to claim 2, wherein said “acquiring a filling pixel for a current position of the target pixel” comprises:
acquiring a target scene image of a previous frame and inter-frame pixel movement information between the target scene image of the previous frame and the original scene image; and
determining an initial pixel at the current position within the exposure period of the original scene image according to the target scene image of the previous frame and the inter-frame pixel movement information, and using the initial pixel as the filling pixel for the current position.

4. The image processing method according to claim 1, wherein said “determining a target pixel in the original scene image and a movement trajectory thereof according to the pixel movement information” comprises:
determining a moving pixel that moves within an exposure period in the original scene image according to the pixel movement information, and using the moving pixel as the target pixel;
determining a starting position of the target pixel within the exposure period according to the pixel movement information; and
generating the movement trajectory of the target pixel according to the starting position and a current position of the target pixel.

5. The image processing method according to claim 1, wherein before acquiring the original scene image, the method further comprises:
capturing a target scene using a standard camera to obtain an original scene image corresponding to the target scene.

6. The image processing method according to claim 5, wherein before acquiring pixel movement information of the original scene image, the method further comprises:
collecting the pixel movement information of the original scene image using an event-driven camera within an exposure period of the original scene image.

7. The image processing method according to claim 1, wherein before determining a target pixel in the original scene image and a movement trajectory thereof according to the pixel movement information, the method further comprises:
using the original scene image as a target scene image when the pixel movement information indicates absence of motion blur, and outputting the target scene image.

8. An image processing apparatus, comprising:
an acquiring module configured for acquiring an original scene image and pixel movement information thereof;
a determining module configured for determining a target pixel in the original scene image and a movement trajectory thereof according to the pixel movement information; and
a restoring module configured for restoring the target pixel according to the movement trajectory to obtain a target scene image corresponding to the original scene image.

9. An image processing device, comprising: a memory, a processor, and a computer program stored on the memory and executable on the processor, wherein the computer program is configured for implementing the image processing method according to claim 1.

10. A computer-readable storage medium, wherein the computer-readable storage medium is configured to store a computer program thereon, and the computer program is configured to be executed by a processor to implement the image processing method according to claim 1.
